(19) United States
(12) Patent Application Publication
(10) Pub. No.: US 2014/0029822 A1
(43) Pub. Date: Jan. 30, 2014

(54) PATIENT-SIZE-ADJUSTED DOSE ESTIMATION

(71) Applicant: Aware, Inc., Bedford, MA (US)

(72) Inventors: James Giulio Cialdea, JR., Woburn, MA (US); William Rodger Hnath, JR., Medford, MA (US)

(21) Appl. No.: 13/909,643

(22) Filed: Jun. 4, 2013

Related U.S. Application Data
(60) Provisional application No. 61/675,405, filed on Jul. 25, 2012.

(51) Int. Cl. G06T 7/00

(52) U.S. Cl. CPC G06T 7/0012
USPC 382/131

(57) ABSTRACT

A computer system and method for estimating patient-size-adjusted dose delivered by a radiological scanning system include receiving a plurality of radiological images of a body and one or more values associated with a CT (computer tomographic) scan performed by the radiological scanning system to acquire the radiological images. A size and volume of the body are estimated based on the plurality of radiological images associated with the CT scan. An estimated dose delivery value is calculated based on the estimated size and volume of the body and on the one or more values associated with the CT scan.

### RELATED APPLICATION

This application claims the benefit of and priority to U.S. Provisional Application No. 61/675,405, filed Jul. 25, 2012, titled “Improved Estimation of Effective Dose”, the entirety of which application is incorporated by reference herein.

### FIELD OF THE INVENTION

The invention relates generally to radiological scanning systems. More specifically, the invention relates to systems and methods for estimating patient-size-adjusted doses delivered by a radiological scanning system.

### BACKGROUND

Radiological examinations are a critical diagnostic tool but carry inherent risk of improper dose delivery or overdose. The purpose of radiation exposure monitoring (REM) is to identify how much radiation patients have absorbed in order to assess the associated health risks to a patient or group of patients. Analysis of radiation exposure information can help caregivers to improve practices that limit unnecessary or unintended radiation exposure while still obtaining diagnostic images of sufficient quality.

With a radiological scanning system, delivered dose estimates are calculated and provided by the scanner equipment, assuming delivery to a standardized cylindrical volume target, which might be made of plastic or some other material that simulates human tissue. In this way, scanner dose delivery can be calibrated according to standardized targets, such as simulation “phantoms”. However, this dose estimate information does not account for the size of the particular patient, which varies widely across the general population; and no adjustment is made to account for the shape, density, or location of the irradiated body parts, each of which can have a substantial impact on the actual radiation dose absorbed and the associated cancer risk. Therefore, the dose delivered as reported by the radiological scanning system often does not accurately reflect the dose received by the patient.

### SUMMARY

In one aspect, the invention features a method for estimating patient-sized-adjusted dose delivered by a radiological scanning system. The method comprises receiving a plurality of radiological images of a body and one or more values associated with a CT (computer tomographic) scan performed by the radiological scanning system to acquire the radiological images. A size and volume of the body are estimated based on the plurality of radiological images associated with the CT scan. An estimated dose delivery value is calculated based on the estimated size and volume of the body and on the one or more values associated with the CT scan.

In another aspect, the invention features a computer program product for estimating patient-size-adjusted dose delivered by a radiological scanning system. The computer program product comprises a non-transitory computer readable storage medium having computer readable program code embodied therewith. The computer readable program code comprising computer readable program code that, if executed, receives a plurality of radiological images of a body and one or more values associated with a CT (computer tomographic) scan performed by the radiological scanning system, computer readable program code that, if executed, estimates a size and volume of the body based on the plurality of radiological images associated with the CT scan, and computer readable program code that, if executed, calculates an estimated dose delivery value based on the estimated size and volume of the body and on the one or more values associated with the CT scan.

In still another aspect, the invention features a computer system for estimating patient-size-adjusted dose delivered by a radiological scanning system. The computer system comprises a network interface that receives a plurality of radiological images of a body and one or more values associated with a CT (computer tomographic) scan performed by the radiological scanning system. The computer system further comprises a processor programmed to estimate a size and volume of the body based on the plurality of radiological images associated with the CT scan and to calculate an estimated dose delivery value based on the estimated volume of the body and on the one or more values associated with the CT scan.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of a patient-size-adjusted dose estimation system including a computer system in communication with a computerized tomography (CT) scanning system over a network.

FIG. 2 is a flow chart of an embodiment of a process for estimating a patient-size-adjusted dose.

### DETAILED DESCRIPTION

Systems and methods described herein estimate radiation dose by automatically detecting and measuring relevant features in radiological images produced by a CT scanner, such as the contours of the irradiated body or other useful features. From such information, these systems and methods estimate the size and volume of the irradiated body and other physiological data that are useful for improved dose estimation. The estimated irradiated volume provides a conversion factor with which to normalize the radiation output of the CT scanner, referred to as the CTDIᵥₒₗ dose index value. The normalized scanner radiation output produces a value, referred to herein as an “Adjusted CTDIᵥₒₗ” dose index value, representing an effective dose delivered for the actual amount of tissue radiated. Using the irradiated volume to perform the normalization operates to remove the size of the body, which varies widely from patient to patient, from the effective dose estimation, thereby enabling comparisons of dose delivery between different CT scanners and scanner operators in a way that can closely reflect effective dose and associated risk to patients.

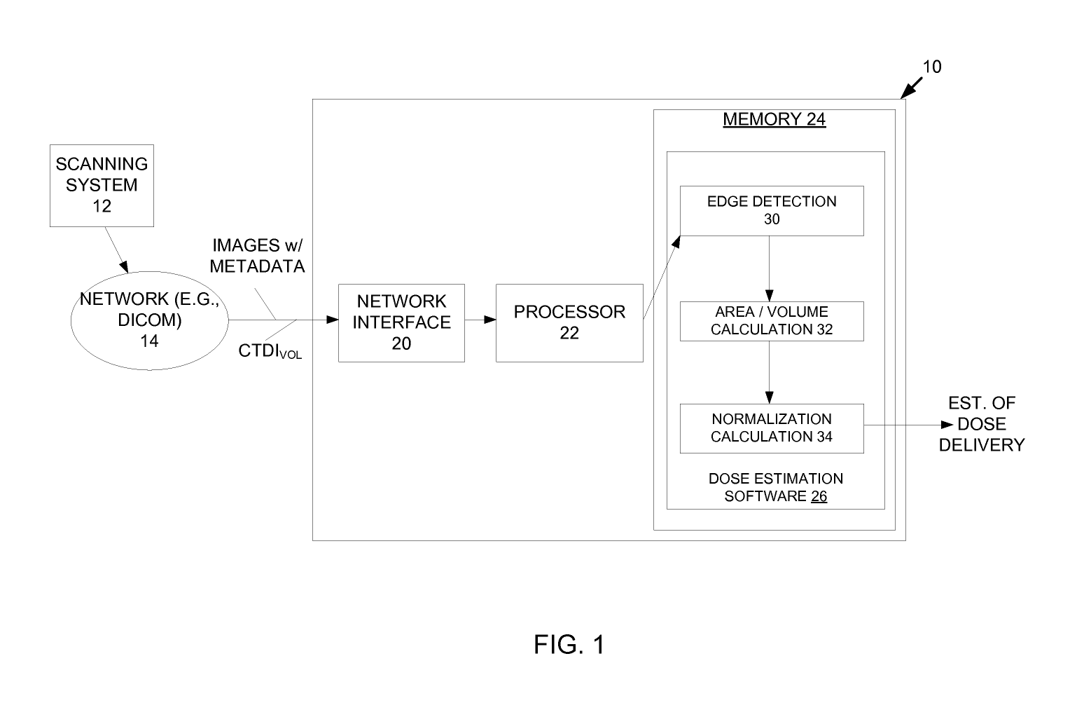

FIG. 1 shows an embodiment of a computing system 10 in communication with a radiological scanning system 12 over a network 14. Embodiments of the network 14 include, but are not limited to, local-area networks (LAN), metro-area networks (MAN), and wide-area networks (WAN), such as the Internet or World Wide Web. The computing system 10 can connect to the radiological scanning system 12 over the network 14 through one or more of a variety of connections, such as standard telephone lines, digital subscriber line (DSL), asynchronous DSL, LAN or WAN links (e.g., T1, T3), broadband connections (Frame Relay, ATM), and wireless connections (e.g., 802.11(a), 802.11(b), 802.11(g)).

In a preferred embodiment, the network 14 is a Digital Imaging and Communications in Medicine (DICOM) network. In brief, DICOM is a standard for handling, storing, printing, and transmitting information in medical imaging. The DICOM standard defines a file format and a network communications protocol. This communication protocol uses TCP/IP to exchange DICOM files between systems capable of receiving image and patient data in DICOM file format. In this embodiment, the computing system 10 is a DICOM-compatible system.

The computing system 10 includes a network interface 20, a processor 22, and memory 24. Example implementations of the computing system 10 include, but are not limited to, personal computers (PC), Macintosh computers, server computers, blade servers, workstations, laptop computers, kiosks, hand-held devices, such as a personal digital assistant (PDA), mobile phones, smartphones, Apple iPads™, Amazon.com KINDLEs®, and network terminals.

The network interface 20 is in communication with the radiological scanning system 12 over the network 14 to receive a set of radiological images associated with an irradiated body. Each radiological image in the set corresponds to a “slice” of the irradiated body. In addition to the set of radiological images, the network interface 20 receives an estimated dose index value (CTDIᵥₒₗ) calculated by the scanning system 12 based on a specific phantom size (e.g., 16 cm, 32 cm).

CTDI is an acronym for Computed Tomography Dose Index, which is a measurement of the average dose imparted from a single axial acquisition in a CT scan. CTDIᵥₒₗ is defined as Volume CTDI, which is a measurement of the CTDI that accounts for the pitch of the applied x-ray beam (i.e., CTDIᵥₒₗ=CTDI_{w}/{Pitch}, where CTDI_{w} is defined as the Weighted CTDI, a measurement of CTDI that accounts for more radiation absorbed on a surface of the irradiated tissue than in the center; and where {Pitch} is defined as {table distance traveled in 360° rotation}/{width of x-ray beam}). CTDIᵥₒₗ is typically measured in mGy (milligray); a Gray is an SI unit of absorbed dose; the value calculated for CTDIᵥₒₗ is independent of the length of the scan; in effect, CTDIᵥₒₗ is a per-slice exposure measurement.

The processor 22 executes a dose estimation program 26 stored in the memory 24. In brief, the dose estimation program 26 calculates an estimate of the delivered dose based on the set of radiological images and the CTDIᵥₒₗ dose index value received from the scanning system 12. The dose estimation program 26 comprises a plurality of software modules, including an edge detection module 30, an area and volume calculation module 32, and a normalization module 34.

The edge detection module 30 includes image-processing software configured to detect and measure relevant features in each radiological image, for example, the contour of the body. The area and volume calculation module 32 is configured to estimate an area covered by the largest detected contour in each radiological image and to compute an irradiated volume by aggregating the irradiated areas computed for the set of radiological images. The normalization module 34 is configured to compute an estimate of dose delivery based on the received CTDIᵥₒₗ value and the computed irradiated volume. This normalization effectively removes the actual size of the irradiated body from the dose estimation.

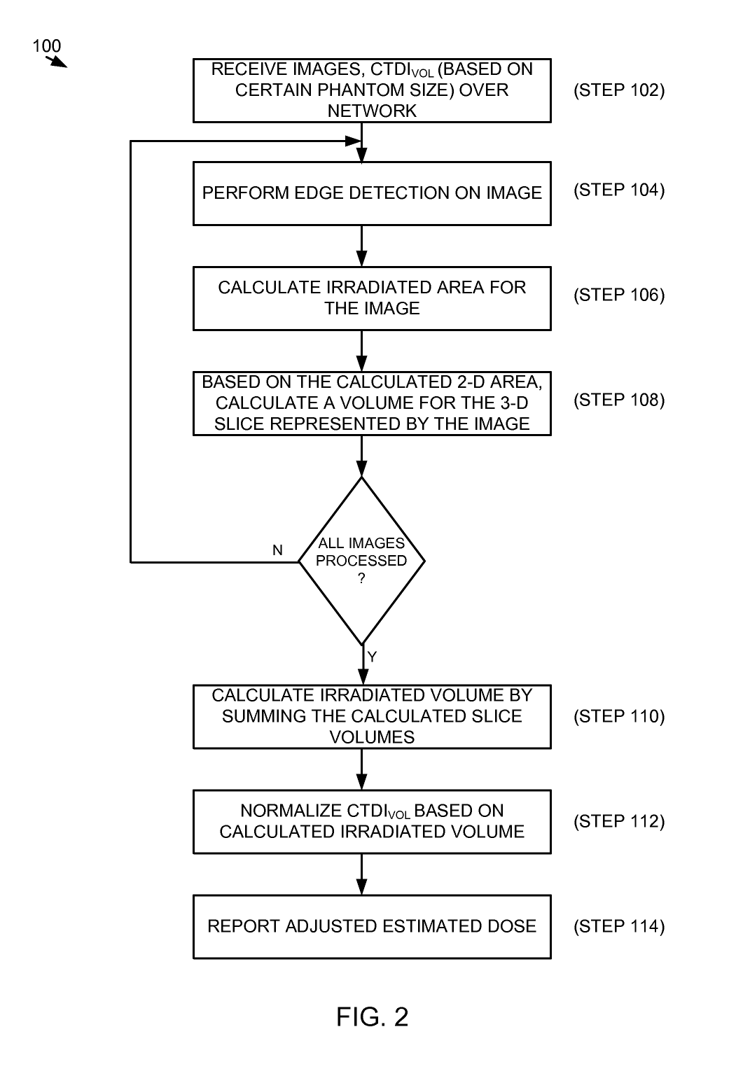

FIG. 2 shows an embodiment of a process 100 for estimating effective dose administered by the radiological scanning system 12. At step 102, the computing system 10 receives a set of radiological images, CT scan metadata (e.g., slice thicknesses), and a CTDIᵥₒₗ value over the network 14. Sets of radiological images typically number between 200 and 500 images, but can occasionally be greater (e.g., 2000 images). The CTDIᵥₒₗ value is based on a specific phantom size. The processor 22 of the computing system 10 runs the dose estimation software 26. For each radiological image, the edge detection module 30 finds (step 104) a largest contour within a radiological image (slice) using image-processing techniques. To accomplish this function, the edge detection module 30 converts the radiological image into a RAW image file. Image-processing techniques include normalizing the grey-scale of the pixels and removing artifacts. To improve contour detection, the edge detection module 30 makes lightly colored pixels lighter and darker colored pixels darker. The outermost detected contour, namely, the contour enclosing a maximum area in the slice, becomes the contour-of-interest for this given slice. Secondary features, such as interior contours, can serve as markers for relation mapping.

The area and volume calculation module 32 calculates (step 106) the area bounded by the contour of each radiological image. In one embodiment, the area and volume calculation module 32 bounds the contour with a best-fit rectangle. This bounding operation simplifies the area calculation to a computation of the 2-D area of the best-fit rectangle. In addition, the best-fit rectangle provides measurement information regarding the size of the body in the given slice, namely, left-right (LAT) and anterior-posterior (AP or front-back) dimensions. The left-right dimension corresponds to the width of the scanned body; the anterior-posterior dimension corresponds to the thickness of the scanned body. Based on the 2-D area calculation for the slice, the area and volume calculation module 32 calculates (step 108) a volume for that slice using a slice thickness. Metadata associated with the image (a provided with the set of radiological images) specifies the slice thickness. Typically, the slice thickness is in the range between 0.5 and 2.0 cm. The area and volume calculation module 32 calculates (step 110) the irradiated volume by summing of the volumes of the individual slices. The set of slice areas provides other information of potential interest, such as the minimum and maximum areas over the full set of radiological images.

The normalization module 34 normalizes (step 112) the CTDIᵥₒₗ value based on the calculated irradiated volume to produce an adjusted CTDIᵥₒₗ value. One example method for normalizing the CTDIᵥₒₗ value based on the calculated volume of the irradiated tissue is to calculate a diameter of a cylinder with a volume equal to the irradiated volume, as illustrated by equation 1:

V(cylinder)=h(eight)(pi)r(adius)̂2 Eq. (1)

where V(cylinder) is equal to the calculated irradiated volume, h is the total scanning length (the distance from the top of the irradiated volume to the bottom) which can be found by multiplying the slice thickness by the number of images, and r is the radius to be derived.

Simplified to equation 2:

r=sqrt(V/(pi*h)) Eq. (2)

The diameter is d=2*r Eq. (3)

This diameter (referred to as an effective diameter) serves as an index into two tables (Table 1D and Table 2D) presented in AAPM Report No. 204, titled “Size-specific Dose Estimates (SSDE) in Pediatric and Adult Body CT Examinations,” May, 2011, the entirety of which is incorporated by reference herein. Based on a given effective diameter, these tables yield a conversion factor. The patient-size-adjusted dose estimation (“adjusted CTDIᵥₒₗ value”) equals the CTDIᵥₒₗ value multiplied by this conversion factor. Table 1D provides conversion factors for CTDIᵥₒₗ values produced from a 32 mm phantom, and Table 2D provides conversion factors for CTDIᵥₒₗ values produced from a 16 mm phantom.

This normalization effectively adjusts the scanner-provided dose estimation by taking the size of the scanned body out of the equation. Removing the size of the body from the dose estimation can enhance the level of confidence in the administered dose. The patient size-independent dose estimations enable comparisons between different scans performed on the same scanning system at different times of the day. The patient size-independent dose estimations can immediately alert technicians to scanning systems that are degrading in performance and to training differences among technicians.

The computing system 10 can report (step 114) the adjusted CTDIᵥₒₗ value (patient size-independent dose estimation) through an output device, for example, a display screen and a printer.

As will be appreciated by one skilled in the art, aspects of the present invention may be embodied as a system, method, and computer program product. Thus, aspects of the present invention may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

The computer readable medium may be a computer readable storage medium, examples of which include, but are not limited to, an electronic, magnetic, optical, electromagnetic, infrared, or semiconductor system, apparatus, or device, or any suitable combination thereof. As used herein, a computer readable storage medium may be any tangible medium that can contain or store a program for use by or in connection with an instruction execution system, apparatus, device, computer, computing system, computer system, or any programmable machine or device that inputs, processes, and outputs instructions, commands, or data. A non-exhaustive list of specific examples of a computer readable storage medium include an electrical connection having one or more wires, a portable computer diskette, a floppy disk, a hard disk, a random access memory (RAM), a read-only memory (ROM), a USB flash drive, an non-volatile RAM (NVRAM or NOVRAM), an erasable programmable read-only memory (EPROM or Flash memory), a flash memory card, an electrically erasable programmable read-only memory (EEPROM), an optical fiber, a portable compact disc read-only memory (CD-ROM), a DVD-ROM, an optical storage device, a magnetic storage device, or any suitable combination thereof.

Program code may be embodied as computer-readable instructions stored on or in a computer readable storage medium as, for example, source code, object code, interpretive code, executable code, or combinations thereof. Any standard or proprietary, programming or interpretive language can be used to produce the computer-executable instructions. Examples of such languages include C, C++, Pascal, JAVA, BASIC, Smalltalk, Visual Basic, and Visual C++.

Transmission of program code embodied on a computer readable medium can occur using any appropriate medium including, but not limited to, wireless, wired, optical fiber cable, radio frequency (RF), or any suitable combination thereof.

The program code may execute entirely on a user's computer, partly on the user's computer, as a stand-alone software package, partly on the user's computer and partly on a remote computer or entirely on a remote computer or server. Any such remote computer may be connected to the user's computer through any type of network, including a local area network (LAN) or a wide area network (WAN), or the connection may be made to an external computer (for example, through the Internet using an Internet Service Provider).

In addition, the described methods can be implemented on an image processing device, fingerprint processing device, or the like, or on a separate programmed general purpose computer having image processing capabilities. Additionally, the methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like. In general, any device capable of implementing a state machine that is in turn capable of implementing the proposed methods herein can be used to implement the image processing system according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The methods illustrated herein however can be readily implemented in hardware and/or software using any known or later developed systems or structures, devices and/or software by those of ordinary skill in the applicable art from the functional description provided herein and with a general basic knowledge of the computer and image processing arts.

Moreover, the disclosed methods may be readily implemented in software executed on programmed general-purpose computer, a special purpose computer, a microprocessor, or the like. In these instances, the systems and methods of this invention can be implemented as program embedded on personal computer such as JAVA® or CGI script, as a resource residing on a server or graphics workstation, as a routine embedded in a dedicated fingerprint processing system, as a plug-in, or the like. The system can also be implemented by physically incorporating the system and method into a software and/or hardware system, such as the hardware and software systems of an image processor.

It is, therefore, apparent that there has been provided, in accordance with the present invention, methods for estimating effective dosages delivered by radiological systems. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents, and variations that are within the spirit and scope of this invention.

What is claimed is:

1. A method for estimating patient-size-adjusted dose delivered by a radiological scanning system, the method comprising:
receiving a plurality of radiological images of a body and one or more values associated with a CT (computer tomographic) scan performed by the radiological scanning system to acquire the radiological images;
estimating a size and volume of the body based on the plurality of radiological images associated with the CT scan; and
calculating an estimated dose delivery value based on the estimated size and volume of the body and on the one or more values associated with the CT scan.

2. The method of claim 1, wherein the radiological images and the one or more values associated with the CT scan are received from the radiological scanning system over a network.

3. The method of claim 2, wherein the network includes a DICOM network

4. The method of claim 1, wherein the one or more values associated with the CT scan includes one or more dose index values.

5. The method of claim 1, wherein estimating a size and volume of the body includes:
performing edge detection on each of the radiological images of the body;
calculating, in response to the edge detection on each of the radiological images associated with the CT scan, an irradiated area associated with that radiological image; and
calculating an irradiated volume based on the calculated irradiated areas.

6. The method of claim 5, wherein the one or more values associated with the CT scan includes a dose index value, and wherein calculating an estimated dose delivery value based on the estimated size and volume of the body and on the one or more values associated with the CT scan includes normalizing the dose index value with the calculated irradiated volume.

7. The method of claim 6, wherein the dose index value is a CTDIᵥₒₗ value calculated by the radiological scanning system using a specific phantom size.

8. Computer program product for estimating patient-size-adjusted dose delivered by a radiological scanning system, the computer program product comprising:
a computer readable storage medium having computer readable program code embodied therewith, the computer readable program code comprising:
computer readable program code that, if executed, receives a plurality of radiological images of a body and one or more values associated with a CT (computer tomographic) scan performed by the radiological scanning system;
computer readable program code that, if executed, estimates a size and volume of the body based on the plurality of radiological images associated with the CT scan; and
computer readable program code that, if executed, calculates an adjusted estimated dose delivery value based on the estimated size and volume of the body and on the one or more values associated with the CT scan.

9. The computer program product of claim 8, wherein the radiological images and the one or more values associated with the CT scan are received from the radiological scanning system over a network.

10. The computer program product of claim 9, wherein the network includes a DICOM network

11. The computer program product of claim 10, wherein the computer readable program code that estimates a size and volume of the body based on the plurality of radiological images includes:
computer readable program code that, if executed, performs edge detection on each of the radiological images of the body;
computer readable program code that, if executed, calculates, in response to the edge detection on each of the radiological images, an irradiated area associated with that radiological image; and
computer readable program code that, if executed, calculates an irradiated volume based on the calculated irradiated areas.

12. The computer program product of claim 10, wherein the one or more values associated with the CT scan includes a dose index value.

13. The computer program product of claim 12, wherein the computer readable program code that calculates an estimated dose delivery value based on the estimated size and volume of the body and on the one or more values associated with the CT scan includes computer readable program code that, if executed, normalizes the dose index value with the calculated irradiated volume.

14. The computer program product of claim 12, wherein the dose index value is a CTDIᵥₒₗ dose index value calculated by the radiological scanning system using a specific phantom size.

15. A computer system for estimating patient-size-adjusted dose delivered by a radiological scanning system, the computer system comprising:
a network interface that receives a plurality of radiological images of a body and one or more values associated with a CT (computer tomographic) scan performed by the radiological scanning system; and
a processor programmed to estimate a size and volume of the body based on the plurality of radiological images associated with the CT scan and to calculate an estimated dose delivery value based on the estimated volume of the body and on the one or more values associated with the CT scan.

16. The computer system of claim 15, wherein the radiological images and the one or more values associated with the CT scan are received by the network interface from the radiological scanning system over a network.

17. The computer system of claim 16, wherein the network includes a DICOM network

18. The computer system of claim 15, wherein the processor is programmed to estimate a size and volume of the body based on the plurality of radiological images by:
performing edge detection on each of the radiological images of the body;
calculating, in response to the edge detection on each of the radiological images associated with the CT scan, an irradiated area associated with that radiological image; and
calculating an irradiated volume based on the calculated irradiated areas.

19. The computer system of claim 15, wherein the one or more values associated with the CT scan includes a dose index value.

20. The computer system of claim 19, wherein the processor is programmed to calculate an estimated dose delivery value based on the estimated size and volume of the body and the one or more values associated with the CT scan by normalizing the dose index value with the calculated irradiated volume.

21. The computer system of claim 19, wherein the dose index value includes a CTDIᵥₒₗ value calculated by the radiological scanning system using a specific phantom size.
